(19) United States
(12) Patent Application Publication
(10) Pub. No.: US 2025/0077079 A1
(43) Pub. Date: Mar. 6, 2025

(54) MEMORY SYSTEMS, ELECTRONIC DEVICES AND OPERATING METHODS THEREOF

(71) Applicant: Yangtze Memory Technologies Co., Ltd., Wuhan (CN)

(72) Inventor: Mo CHENG, Wuhan (CN)

(21) Appl. No.: 18/399,498

(22) Filed: Dec. 28, 2023

(30) Foreign Application Priority Data
Aug. 29, 2023 (CN) 202311114208.1

(51) Int. Cl. G06F 3/06

(52) U.S. Cl. CPC G06F 3/0613; G06F 3/0647; G06F 3/0659; G06F 3/0679

(57) ABSTRACT

Implementations of the present application provide a memory system, an electric device and an operating method thereof. The memory system includes a memory device and a memory controller. The memory device comprises blocks comprising a first storage area and a second storage area. A number of bits stored in each memory cell in the second storage area being less than a number of bits stored in each memory cell in the first storage area. The memory device comprises regions. The memory controller is configured to receive a first instruction and send a command set to the memory device. The command set indicates that data of a hot region in the regions is to be stored in the second storage area. The hot region is determined according to accessed information by a computer program and a data access condition of the computer program.

### CROSS-REFERENCE TO RELATED APPLICATIONS

The present application claims the benefit of priority to China Application No. 202311114208.1, filed on Aug. 29, 2023, the content of which is incorporated herein by reference in its entirety.

### TECHNICAL FIELD

The present disclosure relates to the technical field of semiconductors, and in an example to a host system, a memory system, an electronic device and an operating method, a memory medium.

### BACKGROUND

A memory device is a storage apparatus for storing information in modern information technology. As a typical nonvolatile semiconductor memory, NAND (Not-And) memory has become the mainstream product in the memory market because of its high storage density, controllable production cost, suitable programming and erasing speed and maintenance characteristics.

### SUMMARY

The implementations of the present disclosure propose a host system, a memory system, an electronic device and operating method, a memory medium. A host system provided by the implementations of present disclosure comprises: a host controller coupled to a memory system, the memory system comprising a memory device including a plurality of blocks, the plurality of blocks comprising a first storage area and a second storage area, the number of bits stored in each memory cell in the second storage area being less than the number of bits stored in each memory cell in the first storage area; the memory device including a plurality of regions; the host controller is configured to: send a first instruction indicating storing data of a hot region in the plurality of regions into the second storage area, wherein the hot region is determined according to the accessed information by the computer program and the data access condition of the computer program.

In some implementations, the host controller is configured to: determine the hot region from the plurality of regions; wherein, the data access thresholds for determining the hot region set correspondingly depending on different accessed information by the computer programs are different.

In some implementations, the host controller is configured to: determine a respective region as a hot region when the accessed information by the computer program corresponding to the respective region is frequently-used information and the data access count corresponding to the respective region within a preset duration is greater than a first threshold; and determine the respective region as a hot region when the accessed information by the computer program corresponding to the respective region is not-frequently-used information and the data access count corresponding to the respective region within a preset duration is greater than a second threshold, wherein the first threshold is less than the second threshold.

In some implementations, the host controller is configured to: send a second instruction indicating writing the data to the memory device, before sending the first instruction.

The implementations of present disclosure further provide a memory system, coupled to a host system, comprising: a memory device including a plurality of blocks, the plurality of blocks comprising a first storage area and a second storage area, the number of bits stored in each memory cell in the second storage area being less than the number of bits stored in each memory cell in the first storage area; the memory device including a plurality of regions; a memory controller coupled to the memory device and configured to: receive a first instruction; send a command set indicating that the data of a hot region in the plurality of regions is stored in the second storage area to the memory device in response to the first instruction, wherein the hot region is determined according to the accessed information by the computer program and the data access condition of the computer program.

In some implementations, the command set comprises a third instruction and a fourth instruction; wherein the third instruction indicates reading the data of the hot region in the plurality of regions, and the fourth instruction indicates storing the read data of the hot region into the second storage area.

In some implementations, the memory controller is configured to: receive a second instruction before receiving the first instruction; send a fifth instruction indicating writing the data into the second storage area to the memory device in response to the second instruction; wherein the data is moved from the second storage area to the first storage area when the remaining capacity of the second storage area is less than a preset capacity.

In some implementations, the memory controller is further configured to: determine whether the data of the hot region is in the first storage area or the second storage area in response to the first instruction; send a command set to the memory device if the data of the hot region is in the first storage area, wherein the command set indicates moving the data of the hot region from the first storage area to the second storage area; send a sixth instruction to the memory device if the data of the hot region is in the second storage area, wherein the sixth instruction indicates retaining the data of the hot region in the second storage area.

In some implementations, when the data of the hot region is in the first storage area, the memory controller is further configured to: determine the storage capacity of the hot region and the remaining capacity of the second storage area; move all data of the hot region from the first storage area to the second storage area when the storage capacity of the hot region is smaller than the remaining capacity of the second storage area and the remaining capacity of the second storage area is larger than the preset capacity: move part of the data of the hot region from the first storage area to the second storage area or not move the data of the hot region, when the storage capacity of the hot region is larger than the remaining capacity of the second storage area or the remaining capacity of the second storage area is smaller than the preset capacity.

In some implementations, when the data of the hot region is in the first storage area, the memory controller is configured to: send a command set to the memory device in response to the first instruction, wherein the command set indicates moving the data of the hot region in the plurality of regions from the first storage area to the second storage area when the memory system is in an idle state.

In some implementations, the memory system comprises a general-purpose flash memory device, and the memory device comprises a NAND memory.

The implementations of present disclosure further provide an electronic device comprising a host system and a memory system coupled to the host system, wherein: the memory system comprises a memory device and a memory controller coupled to the memory device, wherein the memory device comprises a plurality of blocks, the plurality of blocks comprise a first storage area and a second storage area, and the number of bits stored in each memory cell in the second storage area is less than the number of bits stored in each memory cell in the first storage area; the memory device includes a plurality of regions; the host system is configured to: send a first instruction; the memory controller is configured to: receive the first instruction; and send a command set to the memory device in response to the first instruction, wherein the command set indicates storing the data of a hot region in the plurality of regions in the second storage area, and the hot region is determined according to the accessed information by the computer program and the data access condition of the computer program.

In some implementations, the host system is configured to: send a second instruction before sending the first instruction; the memory controller is configured to: receive the second instruction and send a fifth instruction to the memory device in response to the second instruction; the fifth instruction indicates writing the data into the second storage area; and move the data from the second storage area to the first storage area when the remaining capacity of the second storage area is less than the preset capacity.

The implementations of present disclosure further provide an operating method of an electronic device, wherein the operating method comprises: a host system of the electronic device sends a first instruction; a memory system of the electronic device receives the first instruction; and store the data of a hot region in a plurality of regions of the memory device into a second storage area of the memory device in response to the first instruction; the hot region is determined according to the accessed information by the computer program and the data access condition of the computer program; the memory system comprises the memory device and a memory controller coupled to the memory device, wherein the memory device comprises a plurality of blocks, the plurality of blocks comprise a first storage area and a second storage area, and the number of bits stored in each memory cell in the second storage area is less than the number of bits stored in each memory cell in the first storage area; the memory device includes a plurality of regions.

In some implementations, the method further comprises: the host system of the electronic device sending a second instruction before sending the first instruction; the memory system of the electronic device receiving the second instruction, and writing the data into the second storage area in response to the second instruction; wherein, the data is moved from the second storage area to the first storage area when the remaining capacity of the second storage area is less than the preset capacity.

The implementations of present disclosure provide a memory medium on which the executable instructions are stored, which when executed by an electronic device can implement the operations of the operating method of the electronic device in above implementations of present disclosure.

### BRIEF DESCRIPTION OF THE DRAWINGS

FIG. 1 is a schematic diagram of an example system having a memory system according to an implementation of the present disclosure.

FIG. 2a is a schematic diagram of an example memory card having a memory system according to an implementation of the present disclosure.

FIG. 2b is a schematic diagram of an example solid-state drive having a memory system according to an implementation of the present disclosure.

FIG. 3a is a schematic diagram of the distribution of memory cells of a three-dimensional NAND memory according to an implementation of the present disclosure.

FIG. 3b is a schematic diagram of an example memory including a peripheral circuit according to an implementation of the present disclosure.

FIG. 4 is a schematic cross-sectional view of memory cell array including a NAND memory string according to an implementation of the present disclosure.

FIG. 5 is a schematic diagram of an example memory device including memory cell array and a peripheral circuit according to an implementation of the present disclosure.

FIG. 6 is a schematic diagram of the composition structure of an electronic device provided by an implementation of the present disclosure.

FIG. 7 is a schematic diagram of instruction communication in an electronic device according to an implementation of the present disclosure.

FIG. 8 is a schematic diagram of the composition structure of another electronic device according to an implementation of the present disclosure.

FIG. 9 is a schematic diagram of operations of the operating method of an electronic device according to an implementation of the present disclosure.

FIG. 10 is a schematic diagram of the composition structure of a memory medium according to an implementation of the present disclosure.

Similar reference numerals in the above drawings (which are not necessarily drawn to scale) may describe similar components in different views. Similar reference numerals with different letter suffixes may denote different examples of similar components. The drawings generally illustrate, by way of example and not limitation, various implementations discussed herein.

### DETAILED DESCRIPTION

Example implementations of the present disclosure will be described in more detail below with reference to the accompanying drawings. Although example implementations of the present disclosure are shown in the drawings, it should be understood that the present disclosure may be implemented in various forms and should not be limited by the detailed description set forth herein. Rather, these implementations are provided to enable a more thorough understanding of the disclosure and to fully convey the scope of the disclosure to those skilled in the art.

A great deal of details is given in the following description to provide a more thorough understanding of the disclosure. However, it will be apparent to those skilled in the art that the present disclosure may be practiced without one or more of these details. Some technical features well known in the art are not described in other examples to avoid confusion with the present disclosure. That is, not all the features of the actual implementations are described herein, and the well-known functions and structures are not described in detail.

In the accompanying drawings, the size and the relative size of the layers, areas and elements may be exaggerated for the sake of clarity.

It should be appreciated that when an element or a layer is referred to as “on”. “adjacent to”, “connected to” or “coupled to” other elements or layers, it may be directly on, adjacent to, connected to or coupled to other elements or layers, or there may be intervening elements or layers. Conversely, when an element is referred to as “directly on,” “directly adjacent to,” “directly connected to,” or “directly coupled to” other elements or layers, there are no intervening elements or layers. It should be appreciated that, although the terms “first,” “second,” “third,” and the like may be used to describe various elements, components, areas, layers, and/or portions, these elements, components, areas, layers, and/or portions should not be limited by these terms. These terms are used only to distinguish one element, component, area, layer, or portion from another element, component, area, layer, or portion. Thus, without departing from the teachings of this disclosure, the first element, component, area, layer, or portion discussed below may be represented as a second element, component, area, layer, or portion. When a second element, component, area, layer, or portion is discussed, it does not mean that a first element, component, area, layer, or portion necessarily exists in the present disclosure.

The spatial relationship terms such as “under”, “below”, “the underlying”, “beneath”, “on”, “the above”, etc. may be used herein for ease of description, and thereby used to describe the relationship of one element or feature shown in the drawings with other elements or features. It should be appreciated that, in addition to the orientations shown in the drawings, the spatial relationship terms may be intended to further include different orientations of the device in use and operation. For example, if the device in the accompanying drawings is turned over, then the element or feature described as “under”, “beneath” or “below” other elements can be oriented to be “on” the other elements or features. Thus, the example terms “under” and “below” may include both up and down orientations. The device may be oriented in other ways (rotated 90 degrees or in other orientations) and the spatial description terms used herein are interpreted accordingly.

The terms used herein is for the purpose of describing implementations only and is not a limitation of the present disclosure. When used herein, the singular forms “a”, “an”, and “the/that” can also be intended to include the plural forms, unless the context clearly indicates otherwise. It should be appreciated that, the terms “comprising” and/or “including”, when used in this specification, can identify the presence of the features, integers, steps, operations, elements and/or components, but do not exclude the presence and addition of one or more other features, integers, steps, operations, elements, components and/or groups. When used herein, the term “and/or” may include any and all combinations of the relevant listed items.

In order to provide a more detailed understanding of the features and technical contents of implementations of the present disclosure, implementations of the present disclosure are described in detail below together with the accompanying drawings, which are provided for illustrative purposes only and are not intended to limit the implementations of the present disclosure.

The memory devices in implementations of the present disclosure include, but are not limited to, a three-dimensional NAND memory which is taken as an example for ease of understanding.

FIG. 1 illustrates a block diagram of an example system 100 having a memory device in accordance with some aspects of the present disclosure. The system 100 may be a mobile phone, desktop computer, laptop computer, tablet computer, vehicle computer, game console, printer, positioning device, wearable electronic device, smart sensor, virtual reality (VR) device, augmented reality (AR) device or any other electronic device having storage therein. As shown in FIG. 1, the system 100 may include a host system 108 and a memory system 102 having one or more memory devices 104 and a memory controller 106. The host system 108 may be a processor of an electronic device (e.g. the central processing unit (CPU)) or a system-on-chip (SoC) (e.g. an application processor (AP)). The host system 108 may be configured to send data to or receive data from memory device 104.

The memory controller 106 is coupled to the memory device 104 and host system 108 and is configured to control memory device 104, according to some implementations. The memory controller 106 may manage data stored in the memory device 104 and communicate with the host system 108. In some implementations, the memory controller 106 is designed to operate in low duty cycles, such as a secure digital (SD) card, compact flash (CF) card, universal serial bus (USB) flash drive or other media for use in electronic devices such as personal calculators, digital cameras, mobile phones, and the like. In some implementations, the memory controller 106 is designed to operate in a high duty cycle solid state disk (SSD) or embedded multimedia card (eMMC), wherein the SSD or eMMC are used as a data storage and enterprise storage array for mobile devices such as smart phones, tablet computers, laptops, and the like.

The memory controller 106 may be configured to control operations of the memory device 104, such as read, erase and program operations. The memory controller 106 may also be configured to manage various functions relating to data stored or to be stored in the memory device 104, including, but not limited to, bad block management, garbage collection, logic to physical address translation, loss balancing, and the like. In some implementations, the memory controller 106 is further configured to process error correction codes (ECC) regarding data read from or written to the memory device 104. The memory controller 106 may also perform any other suitable function such as formatting the memory device 104. The memory controller 106 may communicate with an external device (e.g. host system 108) according to a communication protocol. For example, the memory controller 106 may communicate with the external device through at least one of various interface protocols, such as USB protocol, MMC protocol, peripheral component interconnect (PCI) protocol, PCI-express (PCI-E) protocol, advanced technology attachment (ATA) protocol, serial ATA protocol, parallel ATA protocol, small computer small interface (SCSI) protocol, enhanced small disk interface (ESDI) protocol, integrated drive electronic device (IDE) protocol, Firewire protocol, and the like.

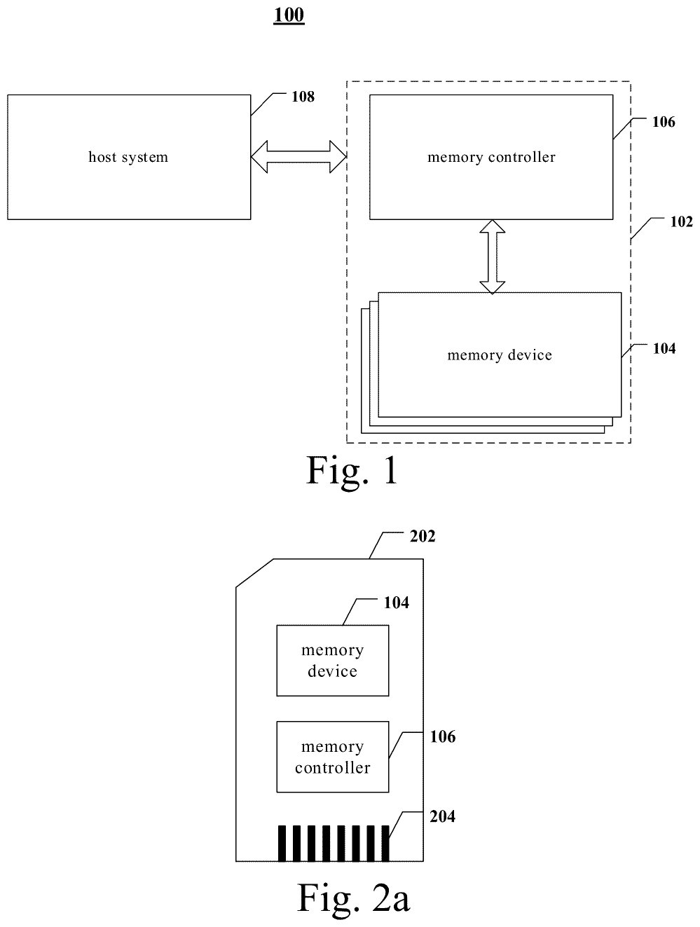

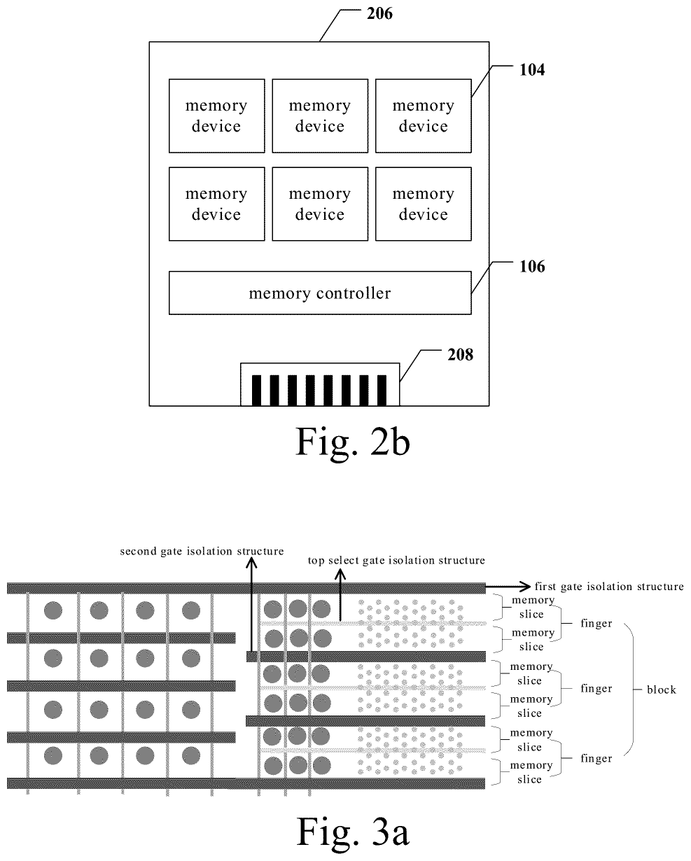

The memory controller 106 and one or more memory devices 104 may be integrated into various types of memory devices, e.g. included in the same package (e.g. universal flash storage (UFS) package or eMMC package). That is, the memory system 102 may be implemented and encapsulated in different types of terminal electronics. In an example as shown in FIG. 2a, the memory controller 106 and a single memory device 104 may be integrated into the memory card 202. The memory card 202 may include a PC card (PCMCIA, Personal Computer Memory Card International Association), CF card, a smart media (SM) card, a memory stick, a multimedia card (MMC, RS-MMC, MMCmicro), a SD card (SD, miniSD, microSD, SDHC), a UFS, and the like. The memory card 202 may also include a memory card connector 204 that couples the memory card 202 to a host (e.g., host system 108 in FIG. 1). In another example as shown in FIG. 2b, the memory controller 106 and a plurality of memory devices 104 may be integrated into the SSD 206. The SSD 206 may also include an SSD connector 208 that couples the SSD 206 to a host (e.g. host system 108 in FIG. 1). In some implementations, the storage capacity and/or operating speed of the SSD 206 is greater than those of the memory card 202.

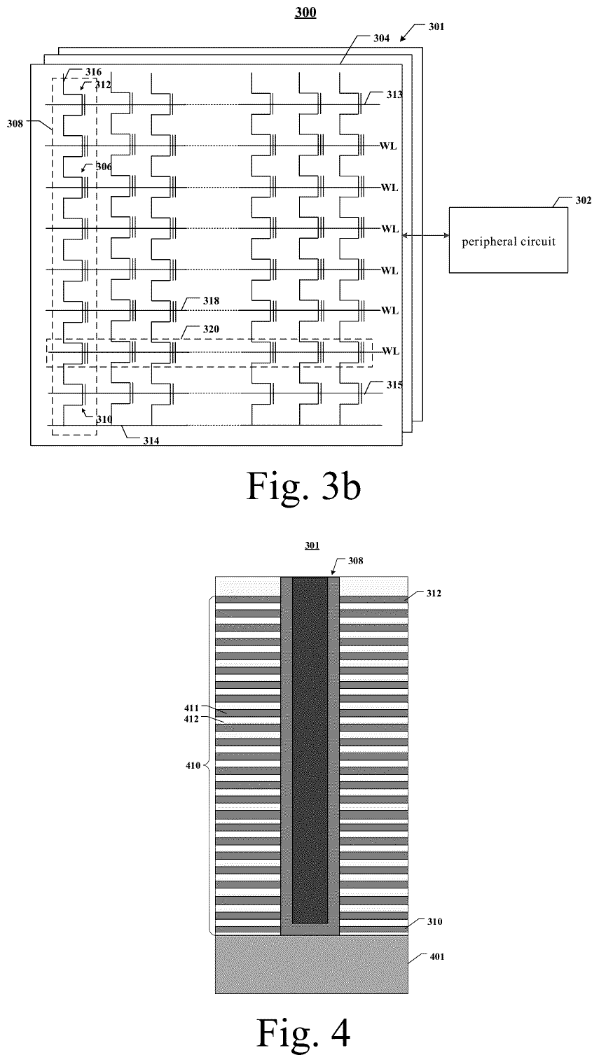

FIG. 3a provides in an example a schematic diagram of the structure of a memory cell array of a three-dimensional (3D) NAND memory. As shown in FIG. 3a, the memory cell array of the 3D NAND memory is composed of a plurality of parallel and staggered rows of memory cell rows parallel to the gate isolation structures. Every two rows of memory cell rows are separated by the gate isolation structure and the top select gate isolation structure. Each of the memory cell rows includes a plurality of memory cells. The gate isolation structure may include first gate isolation structures and second gate isolation structures, wherein the first gate isolation structures divide the memory cell array into a plurality of blocks, and a plurality of second gate isolation structures can divide the blocks into a plurality of fingers. The top select gate isolation structure provided in the middle of each finger may divide the finger into two parts so as to divide the finger into two slices. One block shown in FIG. 3a includes six slices. The number of slices in one block in practice is not limited thereto.

In some implementations, each block may be coupled with a plurality of word lines. A plurality of memory cells coupled to each separately-controlled word line constitute a page. As an example, all memory cells in each slice in FIG. 3a are coupled to constitute a page.

It should be noted that the number of memory cell rows between the gate isolation structure and the top select gate isolation structure shown in FIG. 3a is an example only and is not intended to limit the number of memory cell rows included in one finger of the 3D NAND memory in the present disclosure. In practice, the number of memory cell rows contained in a finger may be adjusted according to the actual situation, such as 2, 4, 8, 16 and so on.

FIG. 3b shows a schematic circuit diagram of an example memory device 300 including a peripheral circuit according to some aspects of the present disclosure. The memory device 300 may be an example of memory device 104 in FIG. 1. The memory device 300 may include a memory cell array 301 and a peripheral circuit 302 coupled to the memory cell array 301. The memory cell array 301 may be illustrated as example of a 3D NAND memory array, in which memory cells 306 are NAND memory cells and provided in the form of an array of memory strings 308, with each memory string 308 extending vertically above a substrate (not shown). In some implementation, each memory string 308 includes multiple memory cells 306 coupled in series and stacked vertically. Each memory cell 306 can hold a continuous analog value, e.g., a voltage or charge, that depends on the number of electrons trapped within an area of the memory cell 306. Each memory cell 306 may be a floating gate type memory cell including a floating gate transistor or a charge trapping type memory cell including a charge trapping transistor.

In some implementations, each memory cell 306 is a single level cell (SLC) having two possible memory states and therefore capable of storing one bit of data. For example, a first memory state “0” may correspond to a first voltage range, and a second memory state “1” may correspond to a second voltage range. In some implementations, each memory cell 306 is a multi-level cells (MLC) storing more than single bit of data in more than four memory states. For example, MLC can store two bits per cell (also known as Double-Level Cell), three bits per cell (also known as Triple-Level Cell (TLC)), four bits per cell (also known as Quad-Level Cell (QLC)), five bits per cell (also known as Penta-level cell (PLC)), or more than five bits per cell. Each MLC may be programmed to take a range of possible nominal stored values. In one example, if each MLC stores two bits of data, the MLC may be programmed to take one of three possible programmed levels from the erased state by writing one of three possible nominal stored values to the cell. The fourth nominal stored value may be used for the erased state.

As shown in FIG. 3b, each memory string 308 may include a bottom select transistor 310 at its source terminal (also known as source select transistor BSG, which includes source select gate) and a top select transistor 312 at its drain terminal (also known as drain select transistor TSG, which includes drain select gate). The source select transistor BSG 310 and drain select transistor TSG 312 may be configured to activate the selected memory string 308 during read and program operations. In some implementations, the sources of the memory strings 308 in the same block 304 are coupled by the same source line (SL) 314 (e.g., a common SL). In another words, according to some implementation, all memory strings 308 in the same block 304 may have an array common source (ACS). According to some implementations, the TSG 312 of each memory string 308 is coupled to a respective bit line (BL) 316, from which data can be read or written via an output bus (not shown). In some implementations, each memory string 308 is configured to be selected or deselected by applying a select voltage (e.g., higher than the threshold voltage of the transistor having the TSG 312) or a deselect voltage (e.g., 0V) to the respective TSG 312 via one or more TSG line 313 and/or by applying a select voltage (e.g., higher than the threshold voltage of the transistor having the BSG 310) or a deselect voltage (e.g., 0V) to the respective BSG 310 via one or more BSG line 315.

As shown in FIG. 3b, the memory strings 308 may be organized into a plurality of blocks 304, each of the plurality of blocks 304 has a common source line 314 (e.g., coupled to ground). In some implementations, each block 304 is a basic unit of data for an erase operation, i.e., all memory cells 306 on the same block 304 are erased at the same time. In order to erase the memory cells 306 in the selected block 304, the source lines 314 of the selected block 304 and unselected blocks 304 on the same plane as the selected block 304 may be biased coupled with an erase voltage (Vers) (e.g. high positive voltage (e.g. 20V or higher)). It should be understood that in some examples, the erase operation may be performed at a half block level, at a quarter block level, or at any suitable fraction of a number of blocks or blocks. The memory cells 306 of adjacent memory strings 308 may be coupled by word lines 318, and the word lines 318 select which row of memory cells 306 is affected by read and program operations. In some implementations, with reference to the above FIG. 3a, a plurality of memory cells are separated by a top select gate isolation structure and a gate isolation structure. A plurality of memory cells between the top select gate isolation structure and the gate isolation structure are arranged in a plurality of memory cell rows, each parallel to the gate isolation structure and the top select gate isolation structure. The memory cells in a slice that share the same word line form a physical page 320. Each physical page 320 may be mapped to at least one logical page according to the storage mode (e.g., SLC or MLC as described above) of the corresponding memory cells 306. The logical page may constitute the basic data unit for program operations and read operations.

Referring to FIG. 3a and FIG. 3b, each memory cell 306 of the plurality of memory cells is coupled to a respective word line 318. Each memory string 308 is coupled to a respective bit line 316 by a respective select transistor, such as a drain select transistor (TSG) 312.

FIG. 4 shows a schematic cross-sectional view of example memory cell array 301 including a memory string 308 (taking NAND as an example) according to some aspects of the present disclosure. As shown in FIG. 4, NAND memory cell array 301 may comprise a stacked structure 410, which includes a plurality of gate layers 411 and a plurality of insulating layers 412 alternately stacked in turn and a channel structure perpendicularly penetrating the gate layers 411 and the insulating layers 412. The channel structure is coupled to each gate layer to form a memory cell, and the channel structure is coupled to a plurality of gate layers in the stacked structure 410 to constitute a memory string 308. The gate layer 411 and the insulating layer 412 may be alternately stacked. Two adjacent gate layers 411 are separated by an insulating layer 412.

The constituent material of the gate layer 411 may include a conductive material. The conductive material includes, but not limited to, tungsten (W), cobalt (Co), copper (Cu), aluminum (Al), polysilicon, doped silicon, silicide, or any combination thereof. In some implementations, each gate layer 411 includes a metal layer, for example, a tungsten layer. In some implementations, each gate layer 411 includes a doped polysilicon layer. Each gate layer 411 may include a control gate surrounding a memory cell. The gate layer 411 at the top of the stacked structure 410 may extend laterally as a top select gate line, and the gate layer 411 at the bottom of the stacked structure 410 may extend laterally as a bottom select gate line, and the gate layer 411 extending laterally between the top select gate line and the bottom select gate line may serve as a word line layer.

In some implementations, a stacked structure 410 may be disposed on a substrate 401. The substrate 401 may include silicon (e.g. monocrystalline silicon), silicon germanium (SiGe), gallium arsenide (GaAs), germanium (Ge), silicon on insulator (SOI), germanium on insulator (GOI) or any other suitable material.

In some implementations, the memory string 308 includes a channel structure that extends vertically through the stacked structure 410. In some implementations, the channel structure includes a channel hole filled with a semiconductor material(s) (e.g. as a semiconductor channel) and a dielectric material(s) (e.g. as a memory film). In some implementations, the semiconductor channel comprises silicon, such as polysilicon. In some implementations, the memory film is a composite dielectric layer including a tunneling layer, a storage layer (also referred to as a “charge trapping/storage layer”) and a barrier layer. The channel structure may have a cylindrical shape (e.g. a pillar shape). According to some implementations, the semiconductor channel, the tunneling layer, the storage layer and the barrier layer are arranged radially from the center of the pillar toward the outer surface of the pillar in this order. The tunneling layer may include silicon oxide, silicon oxynitride, or any combination thereof. The storage layer may include silicon nitride, silicon oxynitride or any combination thereof. The barrier layer may comprise a silicon oxide, silicon oxynitride, high dielectric constant (high k) dielectric or any combination thereof. In one example, the memory film may include a composite layer of silicon oxide/silicon oxynitride/silicon oxide (ONO).

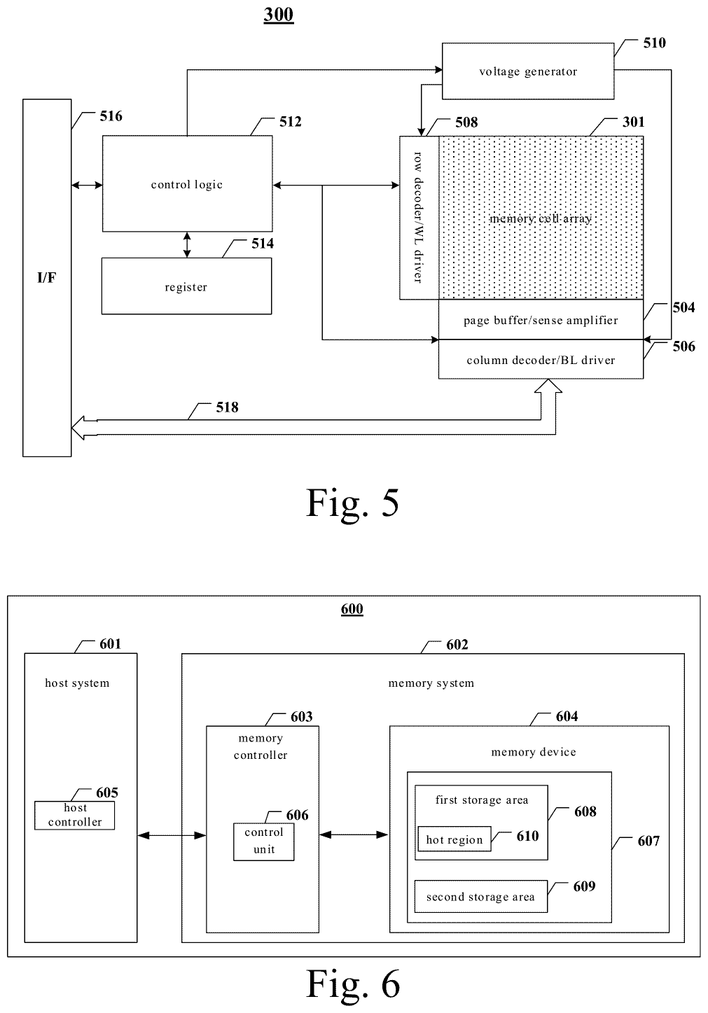

Referring back to FIG. 3b, the peripheral circuit 302 may be coupled to the memory cell array 301 through the bit lines 316, the word lines 318, the source lines 314, the BSG lines 315, and the TSG lines 313. The peripheral circuit 302 may include any suitable analog, digital, and mixed-signal circuit for facilitating operations of the memory cell array 301 by applying and sensing voltage and/or current signals to and from each target memory cell 306 via the bit lines 316, the word lines 318, the source lines 314, the BSG lines 315, and the TSG lines 313. The peripheral circuit 302 may include various types of peripheral circuits formed using metal-oxide-semiconductor (MOS) technology. For example, FIG. 5 shows some example peripheral circuits. The peripheral circuit 302 includes a page buffer/sense amplifier 504, column decoder/bit line driver 506, row decoder/word line driver 508, voltage generator 510, control logic 512, register 514, interface 516, and data bus 518. It should be understood that, in some examples, additional peripheral circuits not shown in FIG. 5 may also be included.

The page buffer/sense amplifier 504 may be configured to read data from the memory cell array 301 and program (write) data to the memory cell array 301 based on a control signal from the control logic 512. In one example, the page buffer/sense amplifier 504 may store the program data (write data) to be programmed into the memory cell array 301. In another example, the page buffer/sense amplifier 504 may perform a program verify operation to ensure that data has been properly programmed into the memory cells 306 coupled to the selected word lines 318. In yet another example, the page buffer/sense amplifier 504 may sense low power signals from the bit lines 316 representing data bits stored in memory cells 306 and amplify small voltage swings to recognizable logic levels in a read operation. The column decoder/bit line driver 506 may be configured to be controlled by the control logic 512 and select one or more memory strings 308 by applying a bit line voltage generated from the voltage generator 510.

The row decoder/word line driver 508 may be configured to be controlled by the control logic 512 and to select/deselect a block 304 of the memory cell array 301 and to select/deselect a word line 318 of the block 304. The row decoder/word line driver 508 may also be configured to drive the word line 318 using the word line voltage generated from the voltage generator 510. In some implementations, the row decoder/word line driver 508 may also select/deselect and drive the BSG lines 315 and TSG lines 313. As described in detail below, the row decoder/word line driver 508 is configured to perform a program operation on the memory cells 306 coupled to the selected word line(s) 318. The voltage generator 510 may be configured to be controlled by the control logic 512 and generate a word line voltage (e.g., a read voltage, a program voltage, a pass voltage, channel boost voltage, a verify voltage, etc.), a bit line voltage, and a source line voltage to be supplied to the memory cell array 301.

The control logic 512 may be coupled to other each part of the peripheral circuits described above and configured to control the operation of other each part of the peripheral circuits. The register 514 may be coupled to the control logic 512 and include a status register, a command register, and an address register for storing status information, a command operation code (OP code), and a command address for controlling the operation of each peripheral circuit. The interface 516 may be coupled to the control logic 512 and act as a control buffer to buffer and relay control commands received from a host system (not shown) to the control logic 512 and to buffer and relay status information received from the control logic 512 to the host system. The interface 516 may also be coupled to the column decoder/bit line driver 506 via data bus 518 and act as a data I/O interface and data buffer to buffer and relay data to or from the memory cell array 301.

As mentioned above, in NAND memory, single-bit memory cell (SLC) has fast reading and writing speed, high reliability, long service life but small storage capacity, while multi-bit memory cell (MLC, TLC, QLC, PLC) has large storage capacity and low cost but slow reading and writing speed. In other words, when single-bit memory cell (SLC) and multi-bit memory cell (MLC, TLC, QLC, PLC) respectively execute read operations, the reading performance difference between them is large, that is, the reading access performance difference between them by a memory system is large. In an example, the memory system has fast reading speed, short reading time and high data access performance when reading the data in single-bit memory cell; while in contrast, the memory system has slow reading speed, long reading time, low data access performance and poor user experience when reading data in multi-bit memory cells.

Based on one or more of the above problems, implementations of the present disclosure provide a host system, a memory system, an electric device and an operating method thereof and a memory medium. The host system comprises a host controller coupled to a memory system, the memory system comprises a memory device including a plurality of blocks, the plurality of blocks comprise a first storage area and a second storage area, the number of bits stored in each memory cell in the second storage area being less than the number of bits stored in each memory cell in the first storage area; the memory device includes a plurality of regions; the host controller is configured to: send a first instruction indicating storing data of a hot region in the plurality of regions into the second storage area, wherein the hot region is determined according to the accessed information by the computer program and the data access condition of the computer program.

Referring to FIG. 6, it shows a schematic diagram of the composition structure of an electronic device. As shown in FIG. 6, the electronic device 600 includes a host system 601 and a memory system 602 connected to the host system 601. The host system 601 may be an electronic device such as a personal computer, a mobile terminal. The host system 601 may include a host controller 605, and in other implementations the host system may also include a host storage area (not shown in FIG. 6). The memory system 602 includes a memory controller 603 for controlling the memory device 604 to perform operations such as read, write and erase, and a memory device 604. The memory controller 603 and the memory device 604 may be coupled in any suitable way. The memory controller 603 may include a control unit 606 for controlling the memory system 602 as a whole. The control unit 606 is, for example, a central processing unit (CPU), a micro processing unit (MPU), or the like.

The memory device 604 may include a plurality of blocks 607, which comprises a first storage area 608 and a second storage area 609. Here, the first storage area and the second storage area may be located in the same block or in two different blocks respectively. FIG. 6 shows the first storage area 608 and the second storage area 609 are located in the same block 607. The first storage area and the second storage area may both include a plurality of memory cells each for storing data. The number of bits stored in each memory cell in the second storage area is less than the number of bits stored in each memory cell in the first storage area. That is, the storage capacity of each memory cell in the second storage area is smaller than the storage capacity of each memory cell in the first storage area. In other words, the reading and writing speed of each memory cell in the second storage area is greater than the reading and writing speed of each memory cell in the first storage area. As an example, the memory cells of the first storage area are all multi-bit memory cells (MLC, TLC, QLC, PLC), and the memory cells of the second storage area are all single-bit memory cells (SLC).

In the implementations of the present disclosure, the memory device may also be divided into a plurality of regions according to the data access condition of the user. The plurality of regions may include hot region(s) and non-hot region(s). Each of the plurality of regions includes a plurality of memory cells. It should be noted that the size of each region in a plurality of regions may be selected and set according to the actual situation. For example, a region may include one or more blocks, or a block may include a plurality of regions. Here, the size of each region is not limited. However, it should be understood that one part of the plurality of regions corresponds to the first storage area and the other part corresponds to the second storage area.

In order to facilitate understanding of the correspondence from the plurality of regions to the first storage area and the second storage area, one of the plurality of regions (e.g., the hot region 610) is shown in FIG. 6 as an example to be located in the first storage area 608. It should be understood that the hot region 610 may be located in the first storage area or the second storage area. A non-hot region (not shown in FIG. 6) may be located in the first storage area or the second storage area. In other implementations, the hot region may also be partially located in the first storage area and the other part is located in the second storage area. In other words, the correspondence from the hot region and the non-hot region to the first storage area and the second storage area may be selected and set according to the actual situation, which is not limited here. Hereinafter, the situation in which the hot region is located in the first storage area is taken as an example, which is described in detail and will not be repeated here.

In some implementations, a plurality of regions of the memory device may be divided into hot region and non-hot region according to accessed information by the computer program and data access conditions of the computer program. In other words, the host controller 605 is further configured to determine the hot region from the plurality of regions, before storing the data of the hot region in the second storage area.

As mentioned above, the hot region is determined according to the accessed information by the computer program and the data access conditions of the computer program. Here, the accessed information by computer programs may be divided into frequently-used information and not-frequently-used information. For example, the region corresponding to frequently-used information is a hot region, and the region corresponding to not-frequently-used information is a non-hot region. The data access condition of the computer program may be determined according to whether the data access count of the respective region reaches the threshold within the preset duration. For example, when the corresponding data access count of the respective region has reached a certain threshold within a preset duration, the respective region is determined as a hot region; and when the corresponding data access count of the respective region has not reached a certain threshold within a preset duration, the respective region is sorted into non-hot region. In some implementations, the hot region may be determined only according to accessed information by the computer program, only according to data access conditions of the computer program, or according to a combination of the two situations. It should be noted that when the hot region is determined according to the combination of two situations, the user may obtain the data of the hot region more flexibly and accurately when reading the data of the hot region, which improves the operation experience of the user.

How to determine a hot region according to the accessed information by the computer program and the data access condition of the computer program is described in detail below in connection with implementations.

In implementations of present disclosure, the data access threshold correspondingly set for determining the hot region is different depending on the different accessed information by the computer program. In an example, a respective region is determined as a hot region when the accessed information by the computer program corresponding to the respective region is frequently-used information and the data access count corresponding to the respective region within a preset duration is greater than a first threshold; the respective region is determined as a hot region when the accessed information by the computer program corresponding to the respective region is not-frequently-used information and the data access count corresponding to the respective region within a preset duration is greater than a second threshold, wherein the first threshold is less than the second threshold.

In other words, when the accessed information by the computer program corresponding to a respective region is frequently-used information and the data access count corresponding to the respective region within a preset duration is less than a first threshold, the respective region is determined as a non-hot region; when the accessed information by the computer program corresponding to the respective region is not-frequently-used information and the data access count corresponding to the respective region within a preset duration is less than a second threshold, the respective region is determined as a non-hot region.

As an example, when the accessed information by the computer program is a frequently-used information, such as WeChat, the data access count of the respective region corresponding to the computer program in unit time (for example, a minute) is 1000, i.e., the first threshold is 1000 times/min. That is, when the accessed information by the computer program is a frequently-used information, the respective region in a plurality of regions corresponding to the data of the computer program is a hot region when the data access count of the respective region in unit time is greater than 1000 times/min; and the respective region is a non-hot region when the data access count of the respective region is less than 1000 times/min in unit time.

As an example, when the accessed information by the computer program is a not-frequently-used information, the data access count of the respective region corresponding to the computer program in unit time (for example, a minute) is 2000, i.e., the second threshold is 2000 times/min. When the accessed information by the computer program is a not-frequently-used information, the respective region in a plurality of regions corresponding to the data of the computer program is a hot region when the data access count of the respective region in unit time is greater than 2000 times/min; and the respective region is a non-hot region when the data access count of the respective region is less than 2000 times/min in unit time.

It should be noted that computer programs may be native programs or software modules in the operating system. It may be a native application (APP), that is, a program that to be installed in the operating system to run, such as WeChat APP. It may also be an applet embedded in any APP, that is, a program that can be run only by downloading it to a browser. In summary, the above-mentioned computer program may be any form of application, module or plug-in.

It is to be explained that the data of the computer program may include data communicated with the computer program. It should be understood that the computer program itself is also stored in a memory device in the form of data. Thus, in other implementations, the data of the computer program may also include data of the computer program itself. In the implementation of the present disclosure, the data to be moved is the data communicated with a computer program. The data of the computer program itself will not be moved.

After determining the hot region, the host controller is configured to: send a first instruction to the memory controller indicating storing the data of a hot region in a plurality of regions in a second storage area.

It should be noted that the precondition for storing the data of the hot region in the second storage area is that the data of the hot region is stored in the first storage area. In other words, it may be determined whether the data of the hot region is stored in the first storage area before moving the data of the hot region. In the implementations of the present disclosure, both the host controller and the memory system (memory controller) may determine whether the data of the hot region is stored in the first storage area. As an example, the host controller makes a determination; and after determining the hot region, the host controller is further configured to: determine whether the data of the hot region is stored in the first storage area; send a first instruction to the memory controller after determining that the data of the hot region is stored in the first storage area. As an example, the memory controller makes a determination; and the host controller directly sends a first instruction to the memory controller after determining the hot region; and the memory controller executes the first instruction after determining that the data of the hot region is stored in the first storage area, in response to the first instruction and determining whether the data of the hot region is stored in the first storage area. The following implementations are explained with the memory system determining whether the data of the hot region is stored in the first storage area as an example. However, it should be understood that the following content with respect to the subject making the determination is for illustration only and is not intended to limit the scope of the present disclosure.

Based on above, the host controller directly transmits a first instruction to the memory controller after determining the hot region. The first instruction is used not only to indicate moving the data of the hot area, but also to characterize which region of the plurality of regions is the hot region. It should be understood that the data of the hot region is frequently-used data of a user. If the data of the hot region is stored in the first storage area, the frequently-used data of the user is moved to the second storage area. The reading speed of the data of the hot region may be improved, the reading time of the data of the hot region may be reduced, the reading performance of the data of the hot region may be improved and thereby the reading experience of the user may be improved.

In some implementations, the host controller may be configured to: send a second instruction indicating writing the data to the memory device, before sending the first instruction.

In other words, before performing the above moving operation, it may be ensured that the data has been written into the first storage area before moving the data in the first storage area. Based on this, the host controller is further configured to send a second instruction to the memory system instructing the memory system to write data to the first storage area in the memory device.

Based on the host system, the implementations of this disclosure provides a memory system coupled to a host system and comprising: a memory device, and a memory controller coupled to the memory device and configured to: receive a first instruction; send a command set indicating storing the data of a hot region in the plurality of regions in the second storage area to the memory device, in response to the first instruction; wherein the hot region is determined according to the accessed information by the computer program and the data access condition of the computer program.

As an example, with reference to FIG. 6, after the host controller 605 sends a first instruction to the memory system 602, the memory controller 603 in the memory system 602 is configured to receive the first instruction. The memory controller 603 sends a command set to the memory device 604 in response to the first instruction. The memory device moves the data according to the received command set. As mentioned above, the memory controller in the memory system may determine the position of the data in the hot region after receiving the first instruction.

In some implementations, the memory controller is further configured to determine whether the data of the hot region is in the first storage area or the second storage area, in response to the first instruction; send a command set to the memory device if the data of the hot region is in the first storage area; the command set indicates moving the data of the hot region from the first storage area to the second storage area; send a sixth instruction to the memory device if the data of the hot region is in the second storage area; wherein the sixth instruction indicates retaining the data of the hot region in the second storage area.

The memory controller receives the first instruction, determines which region of the plurality of regions of the memory device is a hot region according to the indication of the first instruction, and determines whether data of the hot region is stored in the first storage area according to attribute information (e.g. L2P table) corresponding to the hot region. The memory controller sends a command set to the memory device to indicate the memory device to move the data of the hot region in the first storage area to the second storage area, when the data of the hot region is in the first storage area.

It should be noted that the memory device receives a plurality of instructions, such as reading the data of the hot region, moving the data, updating the L2P table and so on, to complete the data moving operation in the process of moving the data of the hot region in the first storage area. Based on above, the command set sent by the memory controller comprises a third instruction and a fourth instruction; wherein the third instruction indicates reading the data of the hot region in the plurality of regions, and the fourth instruction indicates storing the read data of the hot region into the second storage area. In some implementations, the memory controller is further configured to send an update instruction to the memory device after the fourth instruction, wherein the update instruction is to indicate to update the L2P table corresponding to the data of hot region in the memory device. In other implementations, the memory controller is further configured to send a marking instruction to the memory device after the fourth instruction, wherein the marking instruction is to indicate that the data of the hot region in the memory device is marked as invalid.

In some implementations, the command set indicates to move data of a hot region of the plurality of regions from the first storage area to the second storage area while the memory system is in an idle state.

In some implementations, in order to ensure that the memory device can carry out the moving operation of the data of the hot region when the data of the hot region is in the first storage area, the memory controller also may determine whether the remaining capacity of the second storage area in the memory device can store all the data of the hot region before sending the command set.

In some implementations, if the data of the hot region is in the first storage area, the memory controller is further configured to: determine the storage capacity of the hot region and the remaining capacity of the second storage area; move all data of the hot region from the first storage area to the second storage area, when the storage capacity of the hot region is smaller than the remaining capacity of the second storage area and the remaining capacity of the second storage area is larger than the preset capacity; move part of the data of the hot region from the first storage area to the second storage area or not move the data of the hot region, when the storage capacity of the hot region is larger than the remaining capacity of the second storage area or the remaining capacity of the second storage area is smaller than the preset capacity.

When the remaining capacity of the second storage area is larger than the storage capacity of the hot region, it indicates that the second storage area can store all the data of the hot region. However, it should be noted that when the remaining capacity of the second storage area is larger than the preset capacity, all the data of the hot region may be moved to the second storage area; and when the remaining capacity of the second storage area is less than the preset capacity, part of the data of the hot region may be moved to the second storage area; or the data of the hot area may not be moved. Here, the preset capacity is 0-10% of the capacity of the second storage area.

When the remaining capacity of the second storage area is smaller than the storage capacity of the hot region, it indicates that the second storage area can only store part of the data of the hot region. In this case, part of the data of the hot region may be moved to the second storage area according to the difference between the remaining capacity of the second storage area and the storage capacity of the hot region; or the data of the hot region may not be moved.

In addition, the memory controller sends a sixth instruction to the memory device when the data of the hot region is in the second storage area; wherein the sixth instruction indicates still retaining the data of the hot region in the second storage area, that is, the data of the hot region is not to be moved.

The memory cells of the second storage area of the memory device in the implementations of the present disclosure have the characteristic of fast reading and writing speed. The reading speed of the data of the hot region is improved by the host controller sending a first instruction to the memory system indicating storing the data of the hot region of the memory device in the second storage area. Further, the access performance of the memory device may be improved when the data of the hot region is accessed frequently by moving the data of the hot region in the memory device.

It should be understood that, in order to ensure that data has been written to the first storage area prior to moving the data in the first storage area, the memory controller is configured to: receive a second instruction before receiving the first instruction; send a fifth instruction indicating writing the data into the second storage area to the memory device, in response to the second instruction; wherein the data is moved from the second storage area to the first storage area when the remaining capacity of the second storage area is less than a preset capacity during the process in which the data is written to the second storage area. The preset capacity may be select and set according to the actual situation. Here, the speed of writing data to the second storage area is greater than the speed of writing data to the first storage area. In other words, the memory controller first writes data to the second storage area in response to the second instruction and then moves the data of the second storage area to the first storage area, so that the data writing speed can be improved.

In other implementations, the memory controller may be further configured to: send a seventh instruction to the memory device in response to the second instruction; wherein the seventh instruction indicates writing the data directly into the first storage area.

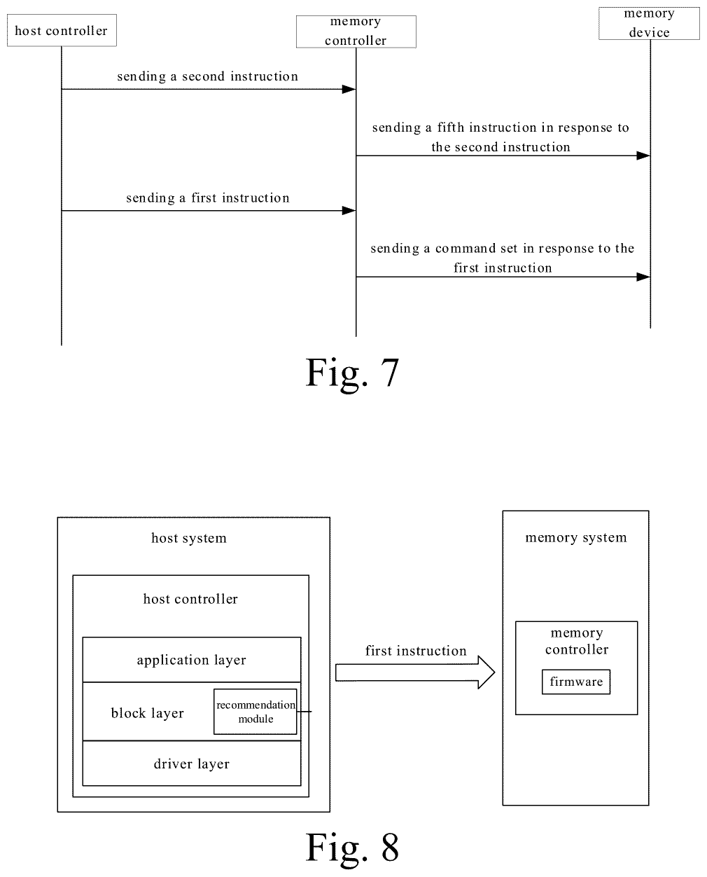

Based on the above-mentioned host system and memory system, an implementation of the present disclosure further provides an electronic device. Referring to FIG. 7, a schematic diagram of instruction communication in an electronic device according to an implementation of the present disclosure is shown. As shown in FIG. 7, the electronic device comprises a host system and a memory system coupled to the host system, wherein: the memory system comprises a memory device and a memory controller coupled to the memory device, wherein the memory device comprises a plurality of blocks, the plurality of blocks comprise a first storage area and a second storage area, and the number of bits stored in each memory cell in the second storage area is less than the number of bits stored in each memory cell in the first storage area; the memory device includes a plurality of regions; the host system is configured to: send a first instruction; the memory controller is configured to: receive the first instruction; and send a command set to the memory device in response to the first instruction, wherein the command set indicates storing the data of a hot region in the plurality of regions in the second storage area, and the hot region is determined according to the accessed information by the computer program and the data access condition of the computer program.

In some implementations, the host system is configured to: send a second instruction before sending the first instruction;

the memory controller is configured to: receive the second instruction and send a fifth instruction to the memory device in response to the second instruction; the fifth instruction indicates writing the data into the second storage area; and move the data from the second storage area to the first storage area when the remaining capacity of the second storage area is less than the preset capacity.

In some implementations, referring to FIG. 8, a schematic diagram of the composition structure of another electronic device provided by one implementation of the present disclosure is shown. The host controller comprises an application layer, a block layer and a driver layer. The application layer may be configured to communicate with the memory system to use the program of the function of the memory system. The block layer is configured to adapt the communication protocol between the host system and the memory system. The block layer also includes a recommendation module which is configured to analyze the data reading conditions, attribute information of computer programs, etc. recommended by the memory system and determine which region of the plurality of regions of the memory device is a hot region according to the analysis result. The application layer may send an input-output request (IOR) to the driver layer for input/output (I/O) operations on the memory device. The IOR may refer to, but not limited to, a data read request, a data store (or write) request, and/or a data drop request. The host controller may also send commands, such as first instructions, converted by the driver layer. The memory controller also includes firmware for monitoring data reading conditions of each of the plurality of regions of the memory device and feeding back the accessed information by the computer program and data access conditions of the computer program corresponding to each region to a recommendation module of the host system. The recommendation module sets a first threshold and a second threshold according to the feedback conditions, and determines which region of the plurality of regions of the memory device is a hot region. The host system sends a first instruction to the memory system after determining the hot region.

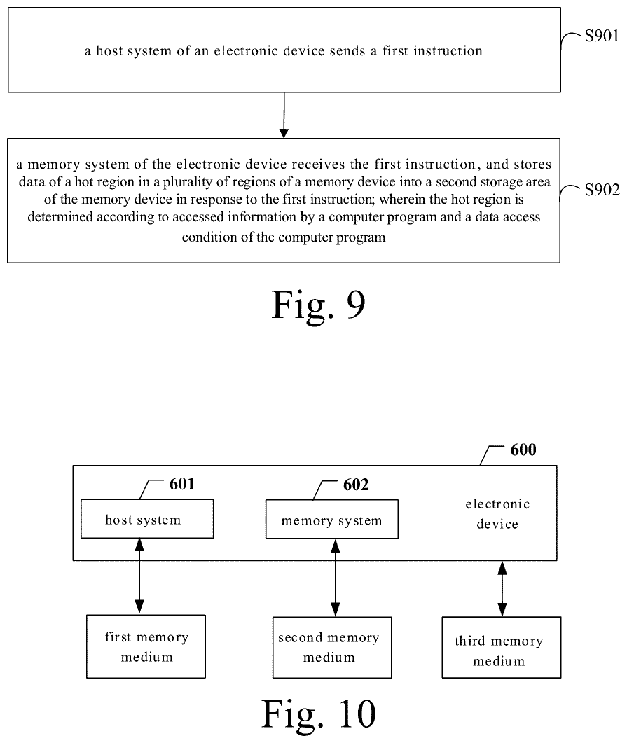

The implementation of the present disclosure also provides an operating method of an electronic device. Referring to FIG. 7 and FIG. 9, FIG. 9 is a schematic diagram of operations of the operating method of an electronic device according to an implementation of the present disclosure. The operating method comprises the following operations:

Operation S901: the host system of the electronic device sends a first instruction.

Operation S902: the memory system of the electronic device receives the first instruction; and store the data of a hot region in a plurality of regions of the memory device into a second storage area of the memory device in response to the first instruction; the hot region is determined according to the accessed information by the computer program and the data access condition of the computer program; the memory system comprises the memory device and a memory controller coupled to the memory device; the memory device comprises a plurality of blocks, the plurality of blocks comprise a first storage area and a second storage area, and the number of bits stored in each memory cell in the second storage area is less than the number of bits stored in each memory cell in the first storage area; the memory device includes a plurality of regions.

In some implementations, the method further comprises: the host system of the electronic device sending a second instruction before sending the first instruction; the memory system of the electronic device receiving the second instruction, and writing the data into the second storage area in response to the second instruction; wherein, the data is moved from the second storage area to the first storage area when the remaining capacity of the second storage area is less than the preset capacity.

In some implementations, the memory system comprises a universal flash storage (UFS) or solid-state disk. The memory device comprises NAND memory.

An implementation of present disclosure further provides a memory medium on which the executable instructions are stored.

In some implementations, the memory medium may be a ferromagnetic random access memory (FRAM), a read only memory (ROM), a programmable read-only memory (PROM), an erasable programmable read-only memory (EPROM), an electrically erasable programmable read-only memory (EEPROM), a flash memory, a magnetic surface memory, optical disc, or a compact disc read-only memory (CD-ROM), and so on, or various devices including one or any combination of the above memory devices.

In some implementations, the executable instructions may be written in any form of programming language (including compiled or interpreted languages or declarative or procedural languages) in the form of program, software, software module, scripts or code, and may be deployed in any form including being deployed as a stand-alone program or as module, component, subroutines or other units suitable for use in computation environment.

As an example, the executable instructions may, but do not necessarily, correspond to files in the file system, and may be stored in a portion of a file holding other programs or data, such as in one or more scripts in an HTML (hyper text markup language) document, in a single file dedicated to the program in question, or in multiple collaborative files (such as files storing one or more module, subroutines or code portions).

As examples, the executable instructions may be deployed to be executed on one electronic device or on multiple electronic devices located at one location, or on multiple electronic devices distributed at multiple locations and interconnected through a communication network.

In some implementations, referring to FIG. 10, a schematic diagram of the composition structure of a memory medium according to an implementation of the present disclosure is shown. The memory medium includes a first memory medium corresponding to a host system, a second memory medium corresponding to a memory system, and a third memory medium corresponding to an electronic device; the first memory medium may be configured to implement the operations of the operating method of the host system in the above-described implementations of the present disclosure when the executable instructions are executed by the host system; the second memory medium may be configured to implement the operations of the operating method of the memory system in the above-described implementations of the present disclosure when the executable instructions are executed by the memory system; the third memory medium may be used to implement the operations of the operating method of the electronic device in the above-described implementations of the present disclosure when the executable instructions are executed by the electronic device.

It should be understood that references to “one implementation” or “an implementation” throughout the specification mean that particular features, structures or characteristics related to the implementations are included in at least one implementation of the present disclosure. Thus, the phrases “in one implementation” or “in an implementation” appearing throughout the specification do not necessarily refer to the same implementation. In addition, these particular features, structures or characteristics may be combined arbitrarily in one or more implementations. It should be understood that in various implementations of the present disclosure, the sequence numbers of the above-mentioned processes do not mean that the sequence of execution, and the sequence of execution should be determined by their functions and inherent logic and should not constitute any limitation to the implementation of the implementations of the present disclosure. The above serial number of implementations of that present disclosure are for description only and do not represent the advantages and disadvantages of the implementation.

The method disclosed in several implementations provided in the present disclosure may be arbitrarily combined without conflict to get new method implementations.

The foregoing are only implementations of the present disclosure, but the scope of protection of the present disclosure is not limited thereto. Any variation or permutation readily contemplated by those skilled in the art within the scope of the present disclosure should be covered within the scope of protection of the present disclosure. Therefore, the scope of protection of this disclosure may be subject to the scope of protection of the claims.

What is claimed is:

1. A memory system, coupled to a host system and comprising:
a memory device comprising blocks, the blocks comprising a first storage area and a second storage area, a number of bits stored in each memory cell in the second storage area being less than a number of bits stored in each memory cell in the first storage area, the memory device comprising regions; and
a memory controller coupled to the memory device and configured to:
receive a first instruction; and
send, in response to the first instruction, a command set to the memory device, the command set indicating that data of a hot region in the regions is to be stored in the second storage area, wherein the hot region is determined according to accessed information by a computer program and a data access condition of the computer program.

2. The memory system of claim 1, wherein the command set comprises a third instruction and a fourth instruction, and wherein the third instruction indicates reading the data of the hot region in the regions, and the fourth instruction indicates storing the data read from the hot region into the second storage area.

3. The memory system of claim 2, wherein the memory controller is configured to:
receive a second instruction before receiving the first instruction; and
send, in response to the second instruction, a fifth instruction to the memory device, the fifth instruction indicating writing data into the second storage area.

4. The memory system of claim 3, wherein the memory controller is configured to:
move the data from the second storage area to the first storage area in response to a remaining capacity of the second storage area is less than a preset capacity.

5. The memory system of claim 3, wherein the memory controller is further configured to:
determine whether the data of the hot region is in the first storage area or the second storage area, in response to the first instruction;
in response to the data of the hot region is in the first storage area, send the command set to the memory device; and
in response to the data of the hot region is in the second storage area, send a sixth instruction to the memory device indicating retaining the data of the hot region in the second storage area.

6. The memory system of claim 5, wherein the command set indicates moving the data of the hot region from the first storage area to the second storage area.

7. The memory system of claim 5, wherein the memory controller is further configured to:
in response to the data of the hot region is in the first storage area, determine a storage capacity of the hot region and a remaining capacity of the second storage area;
in response to the storage capacity of the hot region is smaller than the remaining capacity of the second storage area and the remaining capacity of the second storage area is larger than a preset capacity, move all data of the hot region from the first storage area to the second storage area; and
in response to the storage capacity of the hot region is larger than the remaining capacity of the second storage area or the remaining capacity of the second storage area is smaller than the preset capacity, move part of the data of the hot region from the first storage area to the second storage area or not move the data of the hot region.

8. The memory system of claim 1, wherein the command set indicates moving the data of the hot region in the regions from the first storage area to the second storage area when the memory system is in an idle state.

9. The memory system of claim 1, wherein the memory system comprises a universal flash storage, and the memory device comprises a NAND memory device.

10. An electronic device, comprising:
a host system configured to send a first instruction; and
a memory system coupled to the host system and comprising a memory device and a memory controller coupled to the memory device, wherein the memory device comprises blocks, the blocks comprise a first storage area and a second storage area, and a number of bits stored in each memory cell in the second storage area is less than a number of bits stored in each memory cell in the first storage area, the memory device comprises regions;
wherein the memory controller is configured to:
receive the first instruction from the host system; and
send a command set to the memory device in response to the first instruction, wherein the command set indicates storing data of a hot region in the regions into the second storage area, and the hot region is determined according to accessed information by a computer program and a data access condition of the computer program.

11. The electronic device of claim 10, wherein the host system comprises a host controller coupled to the memory controller and is configured to:
determine the hot region from the regions according to accessed information by a computer program and a data access condition of the computer program.

12. The electronic device of claim 11, wherein depending on different accessed information by the computer program, a data access threshold for determining the hot region which is set correspondingly is different.

13. The electronic device of claim 11, wherein the host controller is configured to:
determine a respective region as a hot region, in response to the accessed information by the computer program corresponding to the respective region is frequently-used information and a data access count corresponding to the respective region within a preset duration is greater than a first threshold; and
determine the respective region as a hot region, in response to the accessed information by the computer program corresponding to the respective region is not-frequently-used information and a data access count corresponding to the respective region within a preset duration is greater than a second threshold, wherein the first threshold is less than the second threshold.

14. The electronic device of claim 11, wherein the host controller is configured to:
send a second instruction indicating writing data to the memory device, before sending the first instruction.

15. The electronic device of claim 14, wherein the memory controller is further configured to:
receive the second instruction;
send a fifth instruction to the memory device in response to the second instruction, wherein the fifth instruction indicates writing data into the second storage area; and
move the data from the second storage area to the first storage area, when a remaining capacity of the second storage area is less than a preset capacity.

16. The electronic device of claim 15, wherein the command set comprises a third instruction and a fourth instruction, and wherein the third instruction indicates reading the data of the hot region in the regions, and the fourth instruction indicates storing the data read from the hot region into the second storage area.

17. A method of operating an electronic device, comprising:
sending, by a host system to a memory system, a first instruction;
receiving, by a memory controller of the memory system, the first instruction; and
in response to the first instruction, storing, by the memory system, data of a hot region in regions of a memory device of the memory system into a second storage area of the memory device, wherein:
the hot region is determined according to accessed information by a computer program and a data access condition of the computer program, and the memory system comprises the memory device and the memory controller coupled to the memory device, wherein the memory device comprises blocks, the blocks comprise a first storage area and a second storage area, and a number of bits stored in each memory cell in the second storage area is less than a number of bits stored in each memory cell in the first storage area, the memory device comprises regions.

18. The method of claim 17, further comprising:
sending, by the host system, a second instruction before sending the first instruction;
receiving, by the memory controller of the memory system, the second instruction; and
writing, by the memory device of the memory system, data into the second storage area in response to the second instruction.

19. The method of claim 18, further comprising:
in response to a remaining capacity of the second storage area is less than a preset capacity, moving the data from the second storage area to the first storage area.

20. The method of claim 17, further comprising:
determining the hot region from the regions according to accessed information by a computer program and a data access condition of the computer program, before sending the first instruction.
